(19) United States
(12) Patent Application Publication
(10) Pub. No.: US 2026/0160197 A1
(43) Pub. Date: Jun. 11, 2026

(54) COOLING SYSTEM FOR A HYBRID VEHICLE AND A CONTROL METHOD THEREOF

(71) Applicants: HYUNDAI MOTOR COMPANY, Seoul (KR); KIA CORPORATION, Seoul (KR)

(72) Inventors: Yeong Jun Kim, Hwaseong-si (KR); Hochan An, Hwaseong-si (KR); Jangsup Na, Hwaseong-si (KR); Soo Yong Park, Hwaseong-si (KR); Yeon Ho Kim, Hwaseong-si (KR); Hyeongmin Kim, Hwaseong-si (KR); Gwi Taek Kim, Hwaseong-si (KR); Hoyoung Jeong, Hwaseong-si (KR); Jeongwoo Cho, Hwaseong-si (KR); Man Hee Park, Hwaseong-si (KR); Jae Yeon Kim, Hwaseong-si (KR); Jeawan Kim, Hwaseong-si (KR)

(73) Assignees: HYUNDAI MOTOR COMPANY, Seoul (KR); KIA CORPORATION, Seoul (KR)

(21) Appl. No.: 19/208,773

(22) Filed: May 15, 2025

(30) Foreign Application Priority Data
Dec. 6, 2024 (KR) 10-2024-0180999

(51) Int. Cl. F01P 3/20; B60K 11/04; F01P 3/18; F01P 7/16

(52) U.S. Cl. CPC F01P 3/20; B60K 11/04; F01P 3/18; F01P 7/164; F01P 7/165; F01P 2003/182; F01P 2023/08; F01P 2050/24; F01P 2060/02

(57) ABSTRACT

A cooling system is for a hybrid vehicle with an engine and an electrical component. The system includes: a cooling module having a cooling fan: an engine cooling apparatus having a first line connected to the cooling module and the engine and through which a first coolant flows; an intercooler ; an electrical component cooling apparatus having a water pump and a second line connected to the cooling module, the electrical component, and the water pump and through which a second coolant flows; and a controller to control operation of the cooling fan and the water pump. The intercooler circulates the second coolant and is disposed in series with the electrical component. The electrical component cooling apparatus includes a bypass line connected to the second line downstream of the cooling module and to the second line upstream of the intercooler, based on a flow direction of the second coolant.

### CROSS-REFERENCE TO RELATED APPLICATION

This application claims priority to and the benefit of Korean Patent Application No. 10-2024-0180999 filed with the Korean Intellectual Property Office on Dec. 6, 2024, the entire contents of which are incorporated herein by reference.

### BACKGROUND OF THE DISCLOSURE

### (A) Technical Field

The present disclosure relates to a cooling system for a hybrid vehicle, and more particularly, the present disclosure relates to a cooling system applied to a hybrid vehicle that has power sources of an engine and a motor.

### (B) Description of the Related Art

Recently, in accordance with continued interest in energy efficiency and reducing environmental pollution, the development of an environmentally-friendly vehicle capable of substantially substituting for an internal combustion engine vehicle is desired. Such environmentally-friendly vehicles may be classified into electric vehicles driven using a fuel cell or electricity as a power source and hybrid vehicles driven using an engine and an electric battery.

Electric vehicles have been developed in which fuel cells are used to generate driving force by converting chemical reaction energy between oxygen and hydrogen into electrical energy. In this process, heat energy is generated by a chemical reaction in the fuel cells. Therefore, it is necessary in securing performance of the fuel cells to effectively remove generated heat.

Further, a hybrid vehicle generates a driving torque by driving a motor using electricity that is supplied from the fuel cell or a battery together with an engine operating with a typical fossil fuel. When heat, generated from electrical components such as a Hybrid Power Control Unit (HPCU), an Oil Pump Control Unit (OPU), a Hybrid Starter Generator (HSG), an inverter, or the like is effectively removed, performance of the motor may be secured.

In other words, in hybrid vehicles, a separate cooling apparatus must be applied to efficiently cool the engine, motor, and multiple electrical components that generate a significant amount of heat.

Additionally, hybrid vehicle engines are equipped with intercoolers to cool the supplied air. Also, a separate cooling apparatus must also be applied to cool the intercooler.

Accordingly, hybrid vehicles generally use a water-cooled cooling system consisting of individual cooling apparatuses that cool the engine, the intercooler, and electrical components by using the cooled coolant. Here, a device, such as a radiator, a reservoir tank, and/or a water pump, is essentially required in each cooling apparatus.

However, the conventional hybrid vehicle has a drawback in that, together with individual cooling apparatuses for preventing heat generation of the engine, motor, electrical components, and battery and an air conditioning system for cooling or heating the vehicle interior, a separate cooling apparatus for cooling the intercooler is essentially required. This causes the manufacturing cost and weight of the vehicle to increase, and it is difficult to secure a space for installing the cooling system.

In addition, a radiator for cooling the coolant is necessarily configured in each cooling apparatus. This causes a drawback in that the size and weight of a cooling module mounted at the front of the vehicle may increase. Also, the layout of connection pipes or lines for supplying the refrigerant or coolant to respective apparatuses becomes complicated in a narrow or small engine compartment.

The above information disclosed in this Background section is only to enhance understanding of the background of the disclosure. Therefore, the Background section may contain information that does not form the prior art that is already known to a person of ordinary skill in the art.

### SUMMARY OF THE DISCLOSURE

The present disclosure provides a cooling system for a hybrid vehicle and a control method thereof. The system and method are capable of reducing the entire components thereby reducing the manufacturing cost and reducing the weight by cooling an intercooler by using an electrical component cooling apparatus configured to cool an electrical component.

A cooling system for a hybrid vehicle having an engine and an electrical component is provided. The cooling system may include a cooling module disposed on an upstream side, i.e., the front end, of a vehicle. The cooling module may include a cooling fan. The cooling system may include an engine cooling apparatus having a first line connected to the cooling module and the engine and through which a first coolant flows. The cooling system may also include an intercooler that may be provided in the engine. The cooling system may further include an electrical component cooling apparatus having a water pump and a second line connected to the cooling module, the electrical component, and the water pump and through which a second coolant flows. The cooling system may also include a controller electrically connected to the cooling fan and the water pump so as to control operation of the cooling fan and the water pump. The intercooler may be connected to the second line to circulate the second coolant and may be disposed in series with the electrical component. The electrical component cooling apparatus may further include a bypass line having a first end connected to the second line at a downstream end of the cooling module and a second end connected to the second line at an upstream end of the intercooler, based on a flow direction of the second coolant.

The second line may be formed to have a different inner diameter than the bypass line.

An air temperature sensor may be associated with the intercooler and may be electrically connected to the controller and configured to measure a temperature of the air in the intercooler.

An electrical component temperature sensor may be associated with the electrical component and may be electrically connected to the controller and configured to measure a temperature of the electrical component.

A coolant temperature sensor may be associated with the second line and may be electrically connected to the controller and configured to measure a temperature of the second coolant flowing through the second line.

The cooling module may further include a first radiator connected to the first line and cooling the first coolant through heat-exchange with ambient air and may include a second radiator connected to the second line and cooling the second coolant through heat-exchange with the ambient air.

The second radiator may be disposed forward of the first radiator based on a front-to-rear direction of the vehicle and the cooling fan may be disposed rearward of the first radiator.

The water pump may be an electric water pump operable within a revolutions per minute (RPM) range according to a control signal of the controller.

A reservoir tank may be connected to the second line.

A control method of a cooling system for a hybrid vehicle having an engine and an electrical component is provided. The cooling system of the hybrid vehicle includes an engine cooling apparatus with a first line connected to the engine and through which a first coolant flows. The cooling system of the hybrid vehicle also include an electrical component cooling apparatus with a water pump and a second line connected to the water pump and the electrical component and through which a second coolant flows. The cooling system of the hybrid vehicle further includes an intercooler coupled with the engine, connected to the second line, and disposed in series with the electrical component. The control method includes procedure (A) of determining, by a controller, an appropriate RPM of the water pump and an appropriate operation duty of a cooling fan, based on data detected from a data detector during starting and operation of the vehicle. The method also includes procedure (B) of driving the water pump and the cooling fan by selecting a maximum appropriate RPM and a maximum appropriate operation duty among an RPM range of the water pump and an operation duty range of the cooling fan determined through procedure (A). The method further includes procedure (C) of determining, by the controller, whether an air temperature and a temperature of the electrical component is within an allowable temperature range of upper and lower allowable temperatures, based on data detected in real time from the data detector, and then controlling the RPM of the water pump and the operation duty of the cooling fan.

Procedure (A) may include the step of starting and driving the vehicle. Procedure (A) may also include the step of detecting, by the controller, the air temperature or a temperature of the second coolant and the temperature of the electrical component, based on the data detected from the data detector. Procedure (A) may further include the step of determining, by the controller, the appropriate RPM of the water pump and the appropriate duty of the cooling fan, depending on the detected air temperature or the detected temperature of the second coolant and the detected temperature of the electrical component.

Procedure (B) may include the step of selecting, by the controller, the maximum appropriate RPM and the maximum appropriate duty from among the RPM range of the water pump and the operation duty range of the cooling fan, respectively. Procedure (B) may also include the steps of driving, by the controller, the water pump at the maximum appropriate RPM and driving the cooling fan at the maximum appropriate operation duty.

The control method may further include determining, by the controller, whether the air temperature or the temperature of the second coolant and the temperature of the electrical component is within the allowable temperature range, based on the data detected in real time from the data detector. The method may also include maintaining, by the controller, the RPM of the water pump and the operation duty of the cooling fan, based on determining that the air temperature or the temperature of the second coolant and the temperature of the electrical component is within the allowable temperature range of upper and lower allowable temperatures (i.e., the condition is satisfied).

The method may also include, in the determining whether the air temperature or the temperature of the second coolant and the temperature of the electrical component is in the allowable temperature range, based on determining that the air temperature or the temperature of the second coolant and the temperature of the electrical component is not within the allowable temperature range of upper and lower allowable temperatures (i.e., when the condition is not satisfied), returning to, i.e., repeating procedure (A) of determining the appropriate RPM of the water pump and the appropriate operation duty of the cooling fan.

The allowable temperature range, i.e., the range of upper and lower allowable temperatures, may be set so that the air temperature or the temperature of the second coolant and the temperature of the electrical component is higher or equal to a predetermined minimum reference temperature and is lower than a predetermined maximum reference temperature when within the range.

The data detector may include an air temperature sensor associated with the intercooler and configured to measure a temperature of the air introduced into the intercooler, an electrical component temperature sensor associated with the electrical component and configured to measure the temperature of the electrical component, and a coolant temperature sensor associated with the second line and configured to measure a temperature of the second coolant.

As described above, according to embodiments of a cooling system for a hybrid vehicle and a control method thereof, by cooling an intercooler using an electrical component cooling apparatus configured to cool an electrical component, the overall number of system components can be reduced and the overall system may be simplified.

In addition, the system and method of the present disclosure can facilitate securing a space for installing the cooling system through streamlining of the entire system and can improve space utilization by reducing the size and weight of a cooling module mounted at the front of the vehicle.

In addition, the system and method of the present disclosure can simplify the layout of connection pipes or lines for flowing the coolant inside the narrow or tight engine compartment. Also, the flow rate of the coolant may be controlled by using the flow resistance of the coolant without employing a valve for controlling the flow direction and flow rate of the coolant.

In addition, by driving the water pump and the cooling fan at a maximum appropriate RPM and a maximum appropriate duty among the RPM range of the water pump and the operation duty range of the cooling fan, depending on the detected air temperature and the temperature of the electrical component, the system and method of the present disclosure can enable more efficient cooling of the electrical component and the intercooler and can improve the performance and efficiency of the entire system.

### BRIEF DESCRIPTION OF THE DRAWINGS

FIG. 1 is a block diagram of a cooling system for a hybrid vehicle according to an embodiment.

FIG. 2 is a block diagram of a cooling system control apparatus to which a control method of a cooling system for a hybrid vehicle according to an embodiment is applied.

FIG. 3 is a control flowchart illustrating a control method of a cooling system for a hybrid vehicle according to an embodiment.

### DETAILED DESCRIPTION OF EMBODIMENTS

Embodiments of the present disclosure are hereinafter described in detail with reference to the accompanying drawings.

Embodiments disclosed in the present specification and the constructions depicted in the drawings are only example embodiments of the present disclosure, and do not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, etc., may be exaggerated for clarity.

In addition, unless explicitly described to the contrary, the words “comprise”, “have”, “include”, and variations thereof such as “comprises” or “comprising”, should be understood to imply the inclusion of stated elements but not the exclusion of any other elements.

Furthermore, each of terms, such as “. . . unit”, “. . . means”, “. . . portions”, “. . . part”, and “. . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

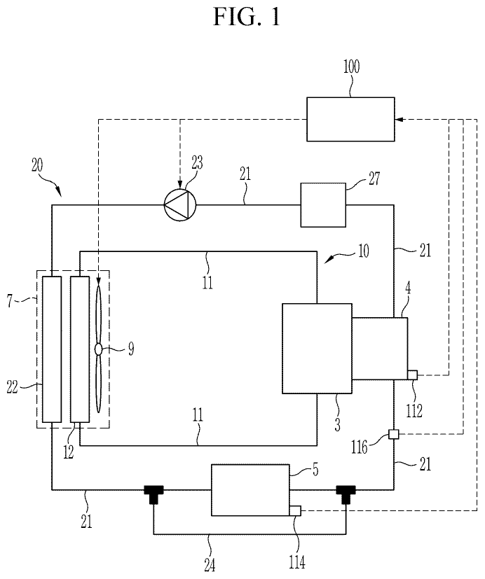

FIG. 1 is a block diagram of a cooling system for a hybrid vehicle according to an embodiment of the present disclosure.

A cooling system for a hybrid vehicle according to an embodiment may be capable of reducing the number of system components thereby reducing the manufacturing cost and reducing the weight of the system. This may be accomplished by cooling an intercooler 4 by using an electrical component cooling apparatus 20 configured to cool an electrical component 5.

Referring to FIG. 1, the cooling system may include the intercooler 4, a cooling module 7, an engine cooling apparatus 10, the electrical component cooling apparatus 20, and a controller 100.

First, the cooling module 7 may be disposed at an upstream end, i.e., a front of the vehicle (relative to the normal driving or movement direction), and may include a cooling fan 9.

The engine cooling apparatus 10 may include a first line 11 connected to the cooling module 7 and through which a first coolant flows, and connected to an engine 3. The engine 3 may be connected to or along the first line 11. The engine 3 may be considered either as being cooled by the cooling system and/or as being a part of the cooling system.

The engine cooling apparatus 10 may further include a mechanical water pump (not shown) provided in the engine 3 or on the first line 11 to impart flow of the first coolant along the first line 11.

The mechanical water pump may be operated by the driving torque of the engine 3.

The engine cooling apparatus 10 configured as such may adjust or control a temperature of the engine 3 by circulating the first coolant along the first line 11 through operation of the mechanical water pump (not shown).

In an embodiment, the intercooler 4 may be provided in, on, adjacent to, or as a part of the engine 3.

The intercooler 4 may cool air that is supplied from a forced induction device (not shown) such as a turbocharger or a supercharger and supply the cooled air to the engine 3.

Here, the intercooler 4 may be configured as a water-cooled intercooler configured to cool the air supplied from the forced induction device by using the coolant. The intercooler 4 may also be considered either as being cooled by the cooling system and/or as being a part of the cooling system.

In an embodiment, the electrical component cooling apparatus 20 may include a second line 21 connected to the cooling module 7 and through which a second coolant flows, and connected to the electrical component 5 and to a water pump 23. The water pump 23 may be connected to or along the second line 21.

Here, the electrical component 5 may include a Hybrid Power Control Unit (HPCU), an Oil Pump Control Unit (OPU), a Hybrid Starter Generator (HSG), an inverter, or the like.

In addition, the electrical component 5 may further include an electric power control unit (EPCU), an on-board charger (OBC), an autonomous driving controller, or the like.

In addition, a reservoir tank 27 may be provided on, i.e., along the second line 21.

Although it is described in an embodiment that the reservoir tank 27 is provided on the second line 21, the system configuration is not limited thereto. The reservoir tank 27 may be connected to the second line 21 through an additional separate line through which the second coolant flows.

The electrical component cooling apparatus 20 configured as such may adjust or control a temperature of the electrical component 5 by circulating the second coolant along the second line 21 through operation of the water pump 23.

Here, the cooling module 7 may further include a first radiator 12 and a second radiator 22.

First, the first radiator 12 may be connected to the first line 11 and may cool the first coolant through heat-exchange with ambient air.

Here, the first radiator 12 may be disposed at the front of the vehicle. The cooling fan 9 may be disposed on a downstream side, i.e., rear end of the first radiator 12. Accordingly, the first radiator 12 may cool the first coolant through operation of the cooling fan 9 and heat-exchange with the ambient air.

In addition, the second radiator 22 may be connected to the second line 21 and may cool the second coolant through heat-exchange with the ambient air.

The second radiator 22 may be disposed on an upstream side, i.e., forward of or in front of the first radiator 12 based on a front-to-rear direction of the vehicle. The second radiator 22 may cool the second coolant through the operation of the cooling fan 9 and heat-exchange with the ambient air.

In an embodiment, the intercooler 4 may be provided on the second line 21 to circulate the second coolant. The intercooler 4 may be disposed in series with the electrical component 5. The electrical component 5 may also be considered either as being cooled by the cooling system and/or as being a part of the cooling system.

Meanwhile, the electrical component cooling apparatus 20 may further include a bypass line 24.

A first end of the bypass line 24 may be connected to the second line 21 at a downstream end or downstream of the cooling module 7, based on a flow direction of the second coolant. In more detail, the first end of the bypass line 24 may be connected to the second line 21 at a downstream end of the second radiator 22.

A second end of the bypass line 24 may be connected to the second line 21 at an upstream end or upstream of the intercooler 4, based on the flow direction of the second coolant.

The electrical component 5 may be provided on or along the second line 21 between the first end and the second end of the bypass line 24 configured in this manner.

In an embodiment, the second line 21 may have a different inner diameter than the bypass line 24.

Accordingly, in the electrical component cooling apparatus 20, when the second coolant flows through the second line 21 and the bypass line 24 having different inner diameters, by using fluid resistance of the second line 21 and the bypass line 24, the flow rate of the second coolant flowing through those lines may be controlled to be different.

In other words, in an embodiment, the intercooler 4 may be cooled by the second coolant in concert with or integrated with the electrical component cooling apparatus 20 having a similar operation temperature of the supplied coolant.

Accordingly, in an embodiment, a separate cooling apparatus that includes a radiator, a coolant line, and a water pump that were conventionally and separately applied in order to cool the intercooler 4 may be eliminated.

Meanwhile, in an embodiment, the electrical component 5 is provided on or along the second line 21 between the first end and the second end of the bypass line 24, but the construction and arrangement of the disclosed system is not limited thereto.

In other words, as described above, the electrical component 5, from among the Hybrid Power Control Unit (HPCU), the Oil Pump Control Unit (OPU), the Hybrid Starter Generator (HSG), the inverter, the electric power control unit (EPCU), the on-board charger (OBC), the autonomous driving controller, or the like, any such component(s) may be provided on or along the second line 21, between the second radiator 22 and the first end of bypass line 24, or between the second end of the bypass line 24 and the intercooler 4, depending on the coolant flow resistance or the amount of heat generation.

In addition, the controller 100 may be electrically connected to the cooling fan 9 and the water pump 23 so as to control the operation of the cooling fan 9 and the water pump 23.

Here, the water pump 23 may be an electric water pump having a speed or revolutions per minute (RPM) capable of being controlled according to a control signal of or from the controller 100.

Further, an air temperature sensor 112 may be electrically connected to the controller 100 and configured to measure a temperature of the air and may be provided in, on, or otherwise as a part of the intercooler 4.

In addition, an electrical component temperature sensor 114 may be electrically connected to the controller 100 and configured to measure the temperature of the electrical component 5 and may be provided in, on, or otherwise as a part of the electrical component 5.

In addition, a coolant temperature sensor 116 may be electrically connected to the controller 100 and configured to measure a temperature of the second coolant flowing through the second line 21 and may be provided in, on, or along the second line 21 upstream of the intercooler 4.

Accordingly, the controller 100 may control operation of the cooling fan 7 and the water pump 23 according to the signals output from the air temperature sensor 112, the electrical component temperature sensor 114, and the coolant temperature sensor 116.

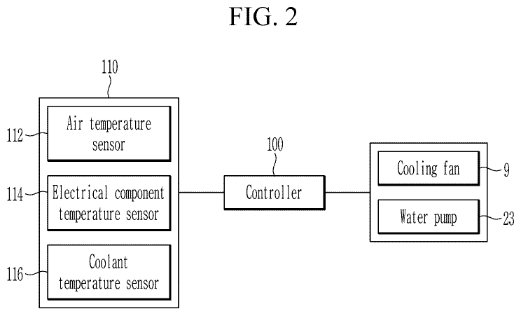

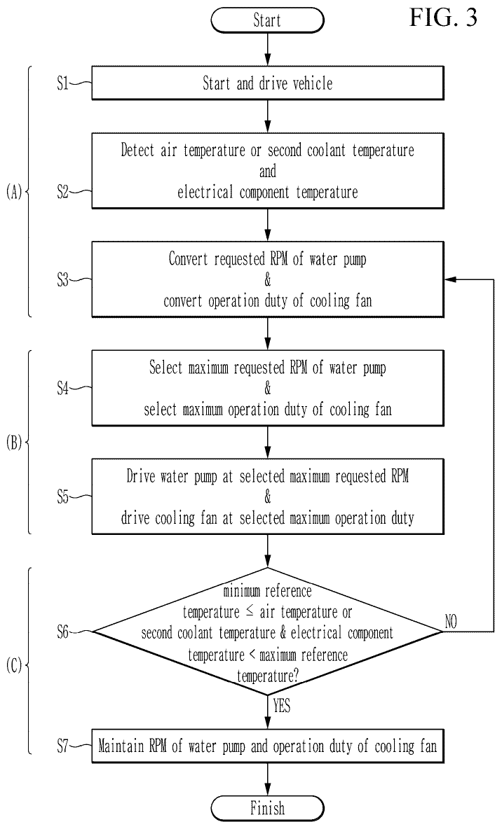

Hereinafter, a control method of a heat pump system for a vehicle configured as described above is described with reference to FIG. 2 and FIG. 3.

FIG. 2 is a block diagram showing a cooling system control apparatus to which a control method of a cooling system for a hybrid vehicle according to an embodiment is applied. FIG. 3 is a control flowchart illustrating a control method of a cooling system for a hybrid vehicle according to an embodiment.

As shown in FIG. 2, in a cooling system for a hybrid vehicle configured as described above, the cooling fan 9 and the water pump 23 included in the electrical component cooling apparatus 20 may be controlled by a cooling system control apparatus. The cooling system control apparatus may include the controller 100 and a data detector 110.

In the present embodiment, the data detector 110 may detect data for the controller 100 to control the operation of the cooling fan 9 and the water pump 23.

The data detected by the data detector 110 may be transferred or transmitted to the controller 100. The data detector 110 may include the air temperature sensor 112, the electrical component temperature sensor 114, the coolant temperature sensor 116, and/or the like.

The air temperature sensor 112 may measure a temperature of the air supplied to the intercooler 4. The air temperature sensor 112 may measure the temperature of the air supplied into the intercooler 4 and may transfer or transmit relevant signals or data to the controller 100.

The electrical component temperature sensor 114 may measure a temperature of the electrical component 4 while the vehicle is driving. The electrical component temperature sensor 114 may measure the temperature of the electrical component 4 and may transfer or transmit relevant signals or data to the controller 100.

In addition, the coolant temperature sensor 116 may measure the temperature of the second coolant introduced into the intercooler 4.

The coolant temperature sensor 116 may measure the temperature of the second coolant introduced into the intercooler 4 through the second line 21 and may transfer or transmit relevant signals or data to the controller 100.

Here, the controller 100 may be implemented as one or more processors operated by a predetermined program. The predetermined program may include a set of instructions for performing respective steps included in a control method of a cooling system according to an embodiment as described below.

Accordingly, in a control method of a cooling system for a hybrid vehicle according to an embodiment, the controller 100 may control the cooling fan 9 and the water pump 23 based on data detected by the data detector 110. The intercooler 4 and the electrical component 5 may thereby be efficiently cooled.

In addition, the cooling fan 9 and the water pump the 23 may be driven at a maximum duty and a maximum RPM among a requested driving RPM of the water pump 23 and an operation duty of the cooling fan 9 depending on the detected air temperature and the temperature of the electrical component 5. By so driving the cooling fan 9 and water pump 23, a control method of a cooling system for a hybrid vehicle according to an embodiment can enable more efficient cooling of the electrical component 5 and the intercooler 4 and can improve the performance and efficiency of the entire system.

For such a purpose, a control method of a cooling system for a hybrid vehicle according to an embodiment is for cooling or controlling a cooling system for a hybrid vehicle (see FIG. 1). As noted above, the hybrid vehicle may include the engine cooling apparatus 10 and the electrical component cooling apparatus 20. Also, in the hybrid vehicle, the intercooler 4 of the engine 3 is provided on the second line 21 and is disposed in series with the electrical component 5. Further, as shown in FIG. 3, the method may include an operation or procedure (A), an operation or procedure (B), and an operation or procedure (C).

In an embodiment, in procedure (A), the controller 100 may convert, i.e., determine or calculate, the requested, i.e., appropriate, RPM of the water pump 23 and the appropriate operation duty of the cooling fan 9 based on data detected from the data detector 110 during starting and operation of the vehicle.

Procedure (A) may include the following steps.

First, at step S1, in a state that the vehicle is started (e.g., turned on), the user may begin to drive the vehicle.

In such a state, at step S2, the controller 100 may detect either the temperature of the air supplied to the intercooler 4 or the temperature of the second coolant introduced into the intercooler 4 and may detect the temperature of the electrical component 5 based on data detected from the data detector 110.

At step S3, the controller 100 may determine the appropriate or required RPM of the water pump 23 and the appropriate or required operation duty of the cooling fan 9 accordingly, depending on the air temperature detected from the data detector 110 or the temperature of the second coolant and on the temperature of the electrical component 5.

In an embodiment, in procedure (B), a maximum requested, i.e., appropriate or required RPM and a maximum operation duty may be selected from among the RPM operation range of the water pump 23 and the operation duty range of the cooling fan 9 determined through procedure (A). The controller 100 may drive the water pump 23 and the cooling fan 9 may be driven based on thereon.

Procedure (B) may include the following steps.

When procedure (A) is completed, the controller 100 may compare the data determined or calculated at the step S3 with the map of the operation duty of the cooling fan 9 and the RPM range of the water pump 23 according to a predetermined temperature. The maximum appropriate RPM and the maximum appropriate operation duty among the RPM range of the water pump 23 and the operation duty range of the cooling fan 9 may be selected, respectively, at step S4.

At step S5, the controller 100 may drive the water pump 23 at the maximum appropriate RPM selected at the step S4, and may drive the cooling fan 9 at the maximum appropriate operation duty selected at step 4.

In addition, in procedure (C), the controller 100 may determine whether the air temperature or the temperature of the second coolant and the temperature of the electrical component 5 is in a range of upper and lower allowable temperatures based on data detected in real time from the data detector 110. The RPM of the water pump 23 and the operation duty of the cooling fan 9 may thereby be controlled accordingly.

Procedure (C) may include the following steps.

When procedure (B) is completed, the controller 100 may determine whether the air temperature or the temperature of the second coolant and a temperature of the electrical component 23 is in the range of upper and lower allowable temperatures based on data detected in real time from the data

### Detector 110, at Step S6.

Here, the range of upper and lower allowable temperatures may be set so that the temperatures detected from the air temperature sensor 112, the electrical component temperature sensor 114, and the coolant temperature sensor 116 or the temperature of the second coolant and the temperature of the electrical component 5 is higher or equal to a predetermined minimum reference temperature and is lower than a predetermined maximum reference temperature.

The range of upper and lower allowable temperatures may be set according to the air temperature detected from a predetermined data map or the temperature of the second coolant and the temperature of the electrical component 5.

When it is determined that the air temperature or the temperature of the second coolant and the temperature of the electrical component 5 is within the range of upper and lower allowable temperatures (i.e., the condition is satisfied; YES) at step S6 of determining whether the air temperature or the temperature of the second coolant and the temperature of the electrical component 5 is within the range of upper and lower allowable temperatures, the controller 100 may maintain the RPM of the water pump 23 and the operation duty of the cooling fan 9 that are currently being driven and terminate the control, respectively, at step S7.

On the other hand, when it is determined that the air temperature or the temperature of the second coolant and the temperature of the electrical component 5 is not within the range of upper and lower allowable temperatures (i.e., when the condition is not satisfied; NO) at step S6 of determining whether the air temperature or the temperature of the second coolant and the temperature of the electrical component 5 is within the range of upper and lower allowable temperatures, the controller 100 may return to the step S3 of determining the appropriate RPM of the water pump 23 and the appropriate operation duty of the cooling fan 9, depending on the detected air temperature or the temperature of the second coolant and the temperature of the electrical component 5.

While performing the above steps, the controller 100 may efficiently control the duty of the cooling fan 9 and the RPM of the water pump 23 according to the temperature of the air supplied to the intercooler 4 or the temperature of the second coolant and the temperature of the electrical component 5.

Therefore, as described above, according to embodiments of a cooling system for a hybrid vehicle and a control method thereof, by cooling the intercooler 4 by using the electrical component cooling apparatus 20 configured to cool the electrical component 5, the overall number of system components can be reduced and the overall system may be simplified.

In addition, the present disclosure can facilitate securing a space for installing the cooling system through streamlining of the entire system. Also, by reducing the size and weight of the cooling module 7 mounted on the front of the vehicle, space utilization may be improved.

In addition, the present disclosure can simplify the layout of connection pipes or lines for flowing the coolant inside the narrow engine compartment.

In addition, according to the present disclosure, by setting inner diameters of the second line 21 and the bypass line 24 to be different from each other without employing a valve for controlling the flow direction and flow rate of the coolant, the flow rate of the coolant may be controlled by using the flow resistance of the coolant.

In addition, by driving the water pump 23 and the cooling fan 9 at the maximum appropriate RPM and maximum appropriate duty among the driving RPM range of the water pump 23 and the operation duty range of the cooling fan 9, depending on the detected air temperature or the temperature of the second coolant and the temperature of the electrical component 23, the present disclosure can enable more efficient cooling of the intercooler 4 and the electrical component 5, and can improve the performance and efficiency of the entire system.

While the technical concepts of this disclosure have been described in connection with what are presently considered to be practical embodiments, it should be understood that the disclosure is not limited to the disclosed embodiments. On the contrary, the present disclosure is intended to cover various modifications and equivalent arrangements included within the spirit and scope of the appended claims.

### DESCRIPTION OF SYMBOLS

3: engine
4: intercooler
5: electrical component
7: cooling module
9: cooling fan
10: engine cooling apparatus
11: first line
12: first radiator
20: electrical component cooling apparatus
21: second line
22: second radiator
23: water pump
24: bypass line
27: reservoir tank
100: controller
110: data detector
112: air temperature sensor
114: electrical component temperature sensor
116: coolant temperature sensor

What is claimed is:

1. A cooling system for a hybrid vehicle having an engine and an electrical component, the cooling system comprising:
a cooling module including a cooling fan;
an engine cooling apparatus including a first line connected to the cooling module and the engine and through which a first coolant flows;
an intercooler;
an electrical component cooling apparatus including a water pump and a second line connected to the cooling module, the electrical component, and the water pump and through which a second coolant flows; and
a controller electrically connected to the cooling fan and the water pump so as to control operation of the cooling fan and the water pump,
wherein the intercooler is connected to the second line to circulate the second coolant and is disposed in series with the electrical component, and
wherein the electrical component cooling apparatus further includes a bypass line having a first end connected to the second line at a downstream end of the cooling module and a second end connected to the second line at an upstream end of the intercooler, based on a flow direction of the second coolant.

2. The cooling system of claim 1, wherein the second line has a different inner diameter than the bypass line.

3. The cooling system of claim 1, wherein an air temperature sensor associated with the intercooler is electrically connected to the controller and is configured to measure a temperature of air in the intercooler.

4. The cooling system of claim 1, wherein an electrical component temperature sensor associated with the electrical component is electrically connected to the controller and is configured to measure a temperature of the electrical component.

5. The cooling system of claim 1, wherein a coolant temperature sensor associated with the second line is electrically connected to the controller and is configured to measure a temperature of the second coolant flowing through the second line.

6. The cooling system of claim 1, wherein the cooling module further comprises:
a first radiator connected to the first line and configured to cool the first coolant through heat-exchange with ambient air; and
a second radiator connected to the second line and configured to cool the second coolant through heat-exchange with the ambient air.

7. The cooling system of claim 6, wherein:
the second radiator is disposed forward of the first radiator based on a front-to-rear direction of the vehicle; and
the cooling fan is disposed rearward of the first radiator.

8. The hybrid a heat pump system of claim 1, wherein:
the water pump is an electric water pump operable with a revolutions per minute (RPM) range according to a control signal of the controller.

9. The cooling system of claim 1, wherein a reservoir tank is connected to the second line.

10. A control method of a cooling system for a hybrid vehicle that includes an engine, an electrical component, an engine cooling apparatus having a first line connected to the engine and through which a first coolant flows, an electrical component cooling apparatus having a water pump connected to a second line through which a second coolant flows, and an intercooler connected to the second line and disposed in series with the electrical component, and the control method comprising procedures:
(A) determining, by a controller, an appropriate revolutions per minute (RPM) of the water pump and an appropriate operation duty of a cooling fan, based on data detected from a data detector during starting and operation of the vehicle;
(B) driving the water pump and the cooling fan by selecting a maximum appropriate RPM and a maximum appropriate operation duty among an RPM range of the water pump and an operation duty range of the cooling fan determined through the procedure (A); and
(C) determining, by the controller, whether an air temperature and a temperature of the electrical component are in an allowable temperature range based on data detected in real time from the data detector, and then controlling the RPM of the water pump and the operation duty of the cooling fan.

11. The control method of claim 10, wherein procedure (A) comprises:
starting and driving the vehicle;
detecting, by the controller, the air temperature or a temperature of the second coolant and the temperature of the electrical component based on data detected from the data detector; and
determining, by the controller, the appropriate RPM of the water pump and the appropriate operation duty of the cooling fan depending on the detected air temperature or the detected temperature of the second coolant and the detected temperature of the electrical component.

12. The control method of claim 10, wherein procedure (B) comprises:
selecting, by the controller, the maximum appropriate RPM and the maximum appropriate operation duty from among the RPM range of the water pump and the operation duty range of the cooling fan, respectively; and
driving, by the controller, the water pump at the maximum appropriate RPM and driving the cooling fan at the maximum appropriate operation duty.

13. The control method of claim 10, further comprising:
determining, by the controller, whether the air temperature or the temperature of the second coolant and the temperature of the electrical component is within the allowable temperature range based on the data detected in real time from the data detector; and
maintaining, by the controller, the RPM of the water pump and the operation duty of the cooling fan, based on determining that the air temperature or the temperature of the second coolant and the temperature of the electrical component is within the allowable temperature range.

14. The control method of claim 13, wherein, based on determining that the air temperature or the temperature of the second coolant and the temperature of the electrical component is not within the allowable temperature range, repeating procedure (A).

15. The control method of claim 13, wherein the allowable temperature range is set so that the air temperature or the temperature of the second coolant and the temperature of the electrical component is higher or equal to a predetermined minimum reference temperature and is lower than a predetermined maximum reference temperature.

16. The control method of claim 10, wherein the data detector comprises:
an air temperature sensor associated with the intercooler and configured to measure a temperature of air introduced into the intercooler;
an electrical component temperature sensor associated with the electrical component and configured to measure the temperature of the electrical component; and
a coolant temperature sensor associated with the second line and configured to measure a temperature of the second coolant.
